(19) United States
(12) Patent Application Publication
(10) Pub. No.: US 2022/0330717 A1
(43) Pub. Date: Oct. 20, 2022

(54) ARTICLE DISPENSING APPARATUS

(71) Applicant: EXCEL CO., LTD., Toda-shi (JP)

(72) Inventor: Tatsunobu KANAYA, Toda-shi (JP)

(73) Assignee: EXCEL CO., LTD., Toda-shi (JP)

(21) Appl. No.: 17/465,387

(22) Filed: Sep. 2, 2021

(30) Foreign Application Priority Data
Apr. 14, 2021 (JP) 2021-068162

(51) Int. Cl. A47F 1/08; G07F 11/44; G07F 11/16; G07F 11/34

(52) U.S. Cl. CPC A47F 1/087; G07F 11/44; G07F 11/163; G07F 11/34

(57) ABSTRACT

An article dispensing apparatus includes: a storage unit configured to store a plurality of articles; and a dispensing unit configured to be provided below the storage unit and dispense at least one article from the storage unit, and the storage unit includes a partition member extending obliquely downward from a one side end portion positioned on one side to an other side end portion positioned on the other side above the dispensing unit to support the articles, and configured to drop the articles from the other side end portion to the dispensing unit.

### BACKGROUND

### Technical Field

The present invention relates to an article dispensing apparatus that dispenses a stored article.

### Related Art

Conventionally, an article dispensing apparatus called Gachapon (registered trademark) is known. As this type of article dispensing apparatus, JP 2007-025856 A discloses a capsule dispensing apparatus using a capsule containing goods as an article.

The apparatus of JP 2007-025856 A includes a storage unit that stores a plurality of capsules, and a dispensing unit that is provided below the storage unit and dispenses one capsule from the storage unit. The dispensing unit is provided with a rotary board that rotates when a user rotates a handle, and the rotary board is formed with a through hole in which one capsule is accommodated. The dispensing unit is provided with a chute hole located below the through hole, and a dispensing port communicating with the chute hole and serving as an outlet of the dispensing unit. Then, when the user operates the handle to rotate the rotary board, the capsule accommodated in the through hole moves together with the rotary board, and the capsule drops at a position where the through hole is located immediately above the chute hole, so that the user can take out the capsule from the dispensing port.

### SUMMARY

Meanwhile, in the conventional article dispensing apparatus, the number of articles that can be stored in the storage unit is limited. This is because, when a large number of articles are stored in the storage unit, a load is applied to each member constituting the dispensing unit due to the weight thereof, which may lead to failure. For example, in a case where capsules having a diameter of about 75 mm are used in a conventional article dispensing apparatus, the number of capsules to be stored in the storage unit is about 100 at the maximum, and there is a risk that a failure of the dispensing unit may occur when the capsules are to be stored any more.

On the other hand, when the number of articles that can be stored in the storage unit increases, the number of types of articles also increases accordingly, so that the appeal effect to the user can be enhanced. In addition, when the number of articles that can be stored in the storage unit increases, the frequency of replenishing the articles to the apparatus can be reduced, and thus the apparatus is excellent also in terms of maintainability.

In view of these points, an object of the present invention is to propose an article dispensing apparatus capable of effectively preventing a failure of the dispensing unit and storing a larger number of articles than before.

The present invention is an article dispensing apparatus including: a storage unit configured to store a plurality of articles; and a dispensing unit configured to be provided below the storage unit and dispense at least one article from the storage unit, wherein the storage unit includes a partition member extending obliquely downward from a one side end portion positioned on one side to an other side end portion positioned on the other side above the dispensing unit to support the articles, and configured to drop the articles from the other side end portion to the dispensing unit.

It is preferable that such an article dispensing apparatus includes a moving member configured to be movably attached to the partition member in a direction from the one side toward the other side, allow the articles to fall from the other side end portion to the dispensing unit when moved to the one side, and prevent the articles from falling from the other side end portion to the dispensing unit when moved to the other side.

Further, in such an article dispensing apparatus, it is preferable that the storage unit includes a rail provided inside an openable and closable door, and a dividing member slidably supported by the rail, and the rail has a notch portion to which the dividing member can be attached at an upper portion of the rail.

Preferably, the dividing member has an opening into which a bar-shaped member can be inserted, and the partition member has a receiving portion that supports the bar-shaped member in a state where the dividing member is slid upward and the bar-shaped member is inserted into the opening.

According to the article dispensing apparatus of the present invention, since the articles stored in the storage unit can be supported from below by the partition member positioned above the dispensing unit, the number of articles whose weight is directly applied to the dispensing unit can be reduced even when more articles are stored. Therefore, it is possible to effectively prevent a failure of the dispensing unit while storing a larger number of articles than before.

### BRIEF DESCRIPTION OF DRAWINGS

FIG. 1 is a perspective view illustrating an embodiment of an article dispensing apparatus according to the present invention;

FIG. 2 is a perspective view illustrating an inside of a storage unit of the article dispensing apparatus illustrated in FIG. 1;

FIG. 3 is a cross-sectional view of the article dispensing apparatus illustrated in FIG. 1 as viewed in a right side view;

FIG. 4 is a cross-sectional view in a right side view in a state where a moving member is moved backward and a dividing member is moved upward;

FIG. 5 is a diagram illustrating a system including the article dispensing apparatus illustrated in FIG. 1;

FIGS. 6A and 6B are diagrams illustrating an example of a website displayed on a user terminal device; and

FIG. 7 is a diagram illustrating an example of a website displayed on a user terminal device.

### DETAILED DESCRIPTION

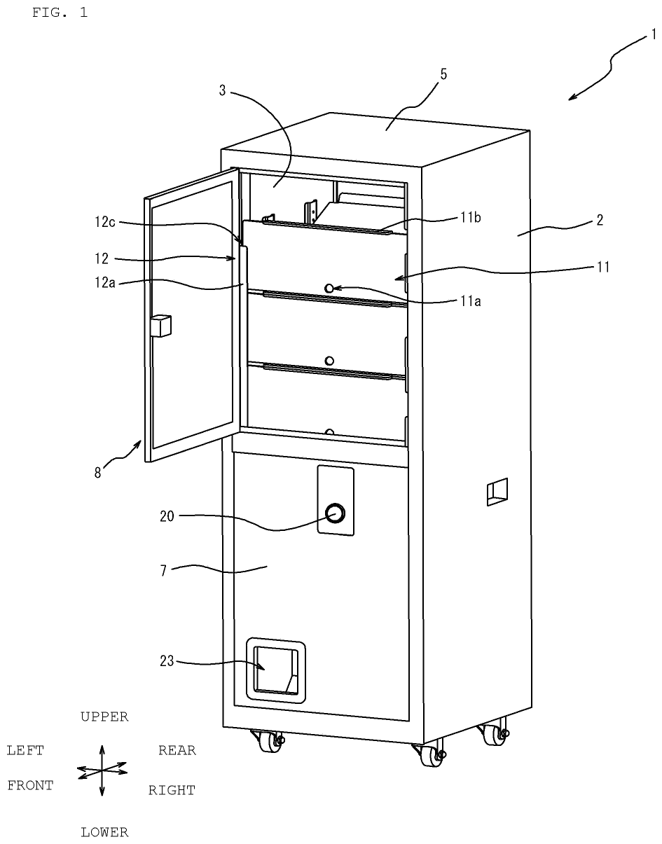

Hereinafter, an embodiment of an article dispensing apparatus according to the present invention will be described with reference to the drawings. In the following description, upper, lower, right, left, front and rear are directions illustrated in FIG. 1.

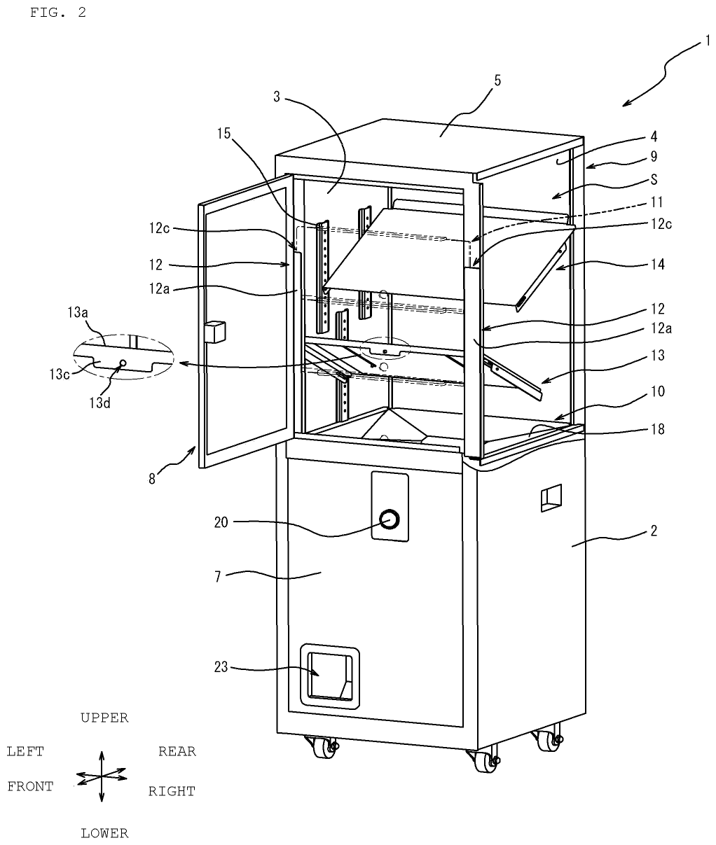

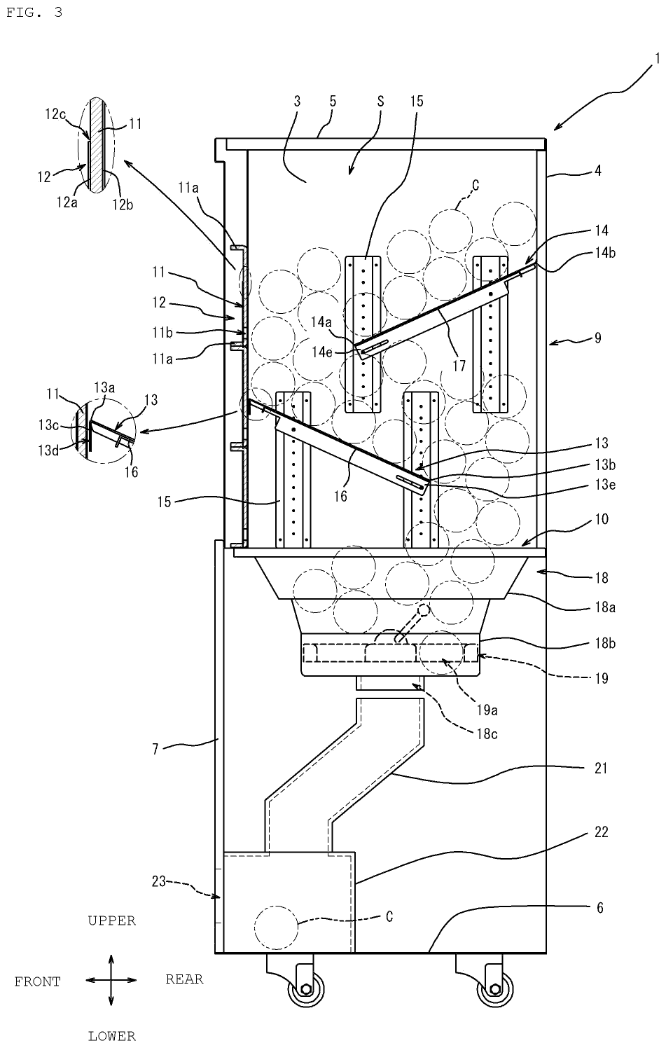

FIG. 1 is a perspective view of an article dispensing apparatus 1 according to an embodiment of the present invention. Note that FIG. 1 illustrates a state in which a door 8 described below is opened. In addition, FIG. 2 illustrates a state in which an inside of the article dispensing apparatus 1 is exposed by breaking a right side part of the article dispensing apparatus 1 and illustrating a dividing member 11 described below by an imaginary line. FIG. 3 is a cross-sectional view of the article dispensing apparatus 1 as viewed in a right side view. The article dispensing apparatus 1 of the present embodiment is configured to dispense spherical capsules C.

The article dispensing apparatus 1 of the present embodiment includes a right panel 2, a left panel 3, a rear panel 4, an upper panel 5, a lower panel 6, a front lower panel 7, and a door 8, and is generally formed in a vertically long rectangular parallelepiped shape. These panels are assembled by screws or the like, and are not removed in normal use. On the other hand, the door 8 is configured to be rotatable about a left side as a fulcrum as illustrated in the drawing. Note that the door 8 is normally closed, and is opened as illustrated in the drawing when the capsules C are replenished or the like. A transparent or translucent material (for example, glass or acrylic resin) is used for the whole or a part of the door 8, and the inside of the door 8 can be visually recognized.

Inside the panels and the door 8 described above, a storage unit 9 having a storage space S in which a plurality of capsules C are stored, and a dispensing unit 10 provided below the storage unit 9 and capable of dispensing one article from the storage unit 9 are provided.

First, the configuration of the storage unit 9 will be described. The storage unit 9 of the present embodiment includes a dividing member 11 having a plate shape, which is provided inside the door 8. The dividing member 11 is entirely or partially transparent or translucent, and in the present embodiment, the entire dividing member 11 is formed of an acrylic resin. The article dispensing apparatus 1 of the present embodiment includes three dividing members 11. As shown in FIGS. 1 and 3, the dividing member 11 of the present embodiment is formed to have a length in a vertical direction of about ¼ of a length in the vertical direction of the door 8, and handle portions 11a protruding forward are provided at an upper portion and a lower portion thereof. As shown in FIG. 1, a circular hole (an opening 11b) is provided at a center of the dividing member 11 in a left-right direction.

As illustrated in FIG. 2, the article dispensing apparatus 1 includes rails 12 located on the left and right of the dividing member 11 inside the door 8. As shown in a partially enlarged view of FIG. 3, the rail 12 is configured such that two plate-shaped portions (a front plate-shaped portion 12a and a rear plate-shaped portion 12b) spaced apart in a front-rear direction extend in the vertical direction, and the dividing member 11 is accommodated between the front plate-shaped portion 12a and the rear plate-shaped portion 12b. Accordingly, the dividing member 11 is supported so as to be vertically slidable with respect to the rail 12. In addition, since a notch portion 12c is provided in an upper portion of the front plate-shaped portion 12a and the length of the front plate-shaped portion 12a is shorter than that of the rear plate-shaped portion 12b, the dividing member 11 can be removed from the rail 12 by sliding upward. When the detached dividing member 11 is attached to the rail 12, the dividing member 11 is inserted between the front plate-shaped portion 12a and the rear plate-shaped portion 12b from the notch portion 12c.

In the present embodiment, the storage space S in which the capsules C are stored is a space defined by the right panel 2, the left panel 3, the rear panel 4, the upper panel 5, and the dividing member 11 above the dispensing unit 10.

Two plate-shaped partition members (a first partition member 13 and a second partition member 14) are provided in the storage space S. The first partition member 13 is provided above a hopper 18 described later. The first partition member 13 extends obliquely downward from a first front side end portion 13a located on the front side thereof to a first rear side end portion 13b located on the rear side thereof. The first front side end portion 13a is located at a position adjacent to the dividing member 11 second from the bottom. The first rear side end portion 13b is located slightly behind a center of the hopper 18 in the front-rear direction, and there is a gap between the first rear side end portion 13b and the rear panel 4. As shown in FIG. 2, a first front bent portion 13c is provided at a center of the first front side end portion 13a in the left-right direction, and a circular hole (a receiving portion 13d) penetrating the first front bent portion 13c is provided. As shown in FIG. 3, a first right side bent portion (not shown in FIG. 3) and a first left side bent portion 13e extending downward are provided at ends of the first partition member 13 in the left-right direction. As illustrated in FIG. 3, outside the first right side bent portion and the first left side bent portion 13e, a pair of brackets 15 having a plurality of holes in the vertical direction are provided on a front side and a rear side inside the right panel 2 and the left panel 3, and circular or long holes conforming to the holes of the brackets 15 are provided in the first right side bent portion and the first left side bent portion 13e. By using a fixing means such as a screw inserted into the holes of the brackets 15 or the holes of the first left side bent portion 13e or the like, the first partition member 13 can be fixed to the brackets 15. The position and angle of the first partition member 13 can be arbitrarily changed by appropriately selecting a plurality of holes provided in the brackets 15.

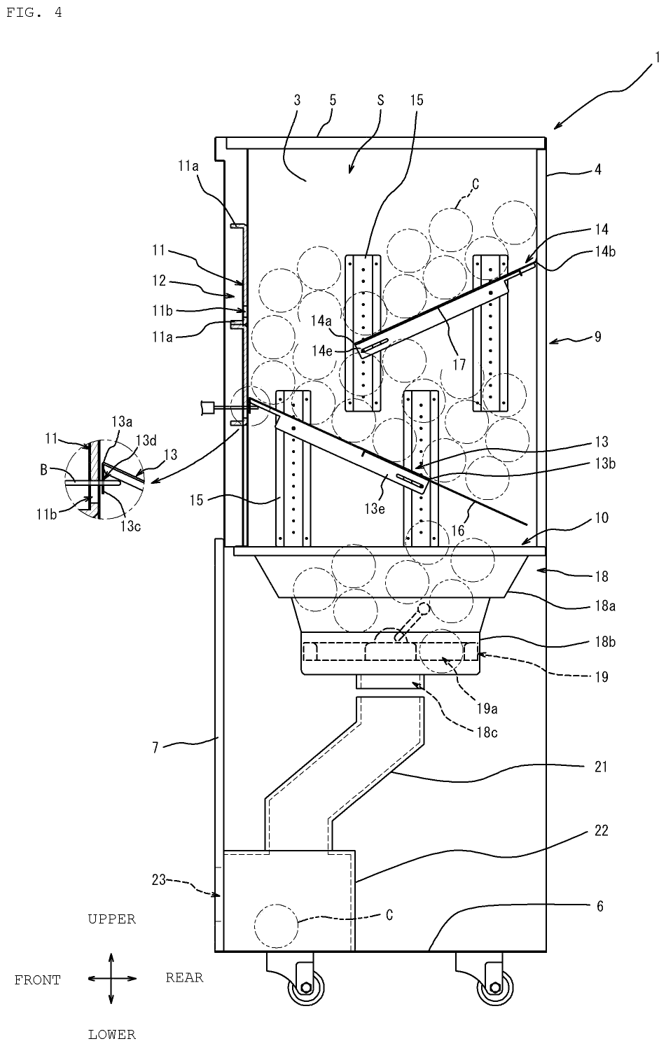

A plate-shaped first moving member 16 which is mounted so as to be movable in a direction from the front side to the rear side along a lower surface of the first partition member 13 is provided below the first partition member 13. Although not illustrated, one of the first partition member 13 and the first moving member 16 is provided with a circular hole, and the other is provided with an elongated hole extending long in the front-rear direction. By using a fixing means such as a screw inserted into these holes, the first moving member 16 can be moved from a state of being hidden inside the first partition member 13 as shown in FIG. 3 to a state of protruding rearward from the first rear side end portion 13b as shown in FIG. 4, and can be fixed at that position. That is, the length of the first partition member 13 can be arbitrarily extended rearward by the first moving member 16.

The second partition member 14 is provided above the first partition member 13, and extends obliquely downward from a second rear side end portion 14b located on the rear side thereof to a second front side end portion 14a located on the front side thereof. The second rear side end portion 14b is located adjacent to the rear panel 4, the second front side end portion 14a is located slightly in front of a center of the hopper 18 in the front-rear direction, and there is a gap between the second front side end portion 14a and the dividing member 11. That is, the second rear side end portion 14b is provided at a position covering an upper side of the gap provided between the first rear side end portion 13b and the rear panel 4. A second right side bent portion (not illustrated in FIG. 3) and a second left side bent portion 14e having the same configuration as the first right side bent portion and the first left side bent portion 13e described above are provided at ends of the second partition member 14 in the left-right direction, and the brackets 15 described above are provided outside the second right side bent portion and the second left side bent portion 14e. The position and angle of the second partition member 14 can also be arbitrarily changed by appropriately selecting a plurality of holes provided in the brackets 15.

Further, a plate-shaped second moving member 17 which is mounted so as to be movable in a direction from the rear side toward the front side along a lower surface of the second partition member 14 is provided below the second partition member 14. The second partition member 14 and the second moving member 17 are also provided with circular or long holes like the first partition member 13 and the first moving member 16. By using a fixing means such as a screw inserted into these holes, the second moving member 17 can be moved from a state of being hidden inside the second partition member 14 (See FIGS. 3 and 4) to a state of protruding forward from the second front side end portion 14a (not illustrated), and can be fixed at that position. That is, the length of the second partition member 14 can be arbitrarily extended forward by the second moving member 17.

Next, a configuration of the dispensing unit 10 will be described. The dispensing unit 10 of the present embodiment includes a hopper 18 located below the storage space S. The hopper 18 of the present embodiment includes a hopper upper portion 18a whose diameter decreases from an upper side to a lower side thereof, and a hopper lower portion 18b having a bottomed cylindrical shape. On an inner side of the hopper lower portion 18b, a rotary board 19 having a disk shape and rotated by a motor (not illustrated) is provided. The motor is configured to be driven by a user pressing a button 20 illustrated in FIG. 1 after inserting coins and bills through a coin/bill insertion port (not illustrated).

The rotary board 19 is provided with a plurality of (four in the present embodiment) through holes 19a at intervals in a circumferential direction, each accommodating one capsule C. Note that one chute hole 18c through which the capsule C can pass is provided at the bottom of the hopper lower portion 18b, and when the rotary board 19 rotates, one capsule C accommodated in the through holes 19a falls from the chute hole 18c.

Below the chute hole 18c, a chute portion 21 having a hollow shape and extending obliquely from the rear side to the front side is provided. A box 22 having a box shape and connected to the chute portion 21 is provided below the chute portion 21. As a result, the capsule C dropped from the chute hole 18c moves to the box 22. As illustrated in FIG. 1, a dispensing port 23 is provided on the front side of the box 22, and a user can take out the capsule C from the dispensing port 23.

In such an article dispensing apparatus 1, since the entire or a part of the door 8 is transparent or translucent and the dividing member 11 is also transparent or translucent, a user can visually recognize the capsules C stored in the storage space S from the outside. As will be described later, the article dispensing apparatus 1 of the present embodiment can store a larger number of capsules C in the storage space S than before, and thus can present various capsules C to a user, and thus has a higher appeal effect than before. The first partition member 13 is provided above the hopper 18, and the capsules C are supported by the first partition member 13 from below, so that the number of capsules C that applies weight directly to the rotary board 19 can be reduced. In particular, in the present embodiment, since the second partition member 14 provided above the first partition member 13 is provided at a position covering the upper side of the gap provided between the first rear side end portion 13b and the rear panel 4, the number of capsules C that applies weight directly to the rotary board 19 from the gap is also reduced. Therefore, even when a large number of capsules C are stored in the storage space S, it is possible to effectively prevent failure of the rotary board 19. As a result of checking by the article dispensing apparatus 1 of the present embodiment, about 350 capsules C having a diameter of about 75 mm can be stored in the storage space S, and even in this state, it is possible to effectively prevent failure of the rotary board 19.

Since the first partition member 13 extends obliquely downward from the first front side end portion 13a to the first rear side end portion 13b, the capsules C positioned between the first partition member 13 and the second partition member 14 move toward the gap provided between the first rear side end portion 13b and the rear panel 4 by their own weight. Since the second partition member 14 extends obliquely downward from the second rear side end portion 14b to the second front side end portion 14a, the capsules C positioned above the second partition member 14 move toward the gap provided between the second front side end portion 14a and the dividing member 11 by their own weight. That is, since the capsules C in the storage space S smoothly move toward the hopper 18 under one continuous flow in which the capsules C move from the rear side to the front side above the second partition member 14 and then move from the front side to the rear side above the first partition member 13, it is possible to effectively suppress a problem such as clogging of the capsules C in the middle.

Incidentally, there is a conventional article dispensing apparatus that opens an upper panel when replenishing articles to a storage unit, but when the storage unit is enlarged so as to be able to store a large number of capsules C, the height of the article dispensing apparatus increases, and workability when opening the upper panel deteriorates. On the other hand, the article dispensing apparatus 1 of the present embodiment is excellent in workability because the capsules C can be replenished by opening the door 8 provided on the front side.

In addition, even if the door 8 is opened in a state where a relatively large number of capsules C remain in the storage space S, the capsules C do not roll down to the outside of the article dispensing apparatus 1 by the dividing member 11. That is, according to the article dispensing apparatus 1 of the present embodiment, it is also possible to frequently replenish the capsules C. Note that the dividing member 11 may remain attached when the capsules C are replenished, but it is easy to replenish the capsules C by removing the dividing member, and damage to the capsules C can be prevented. That is, when the capsules C are replenished while the dividing member 11 is attached in a state where the remaining amount of the capsules C is small, the capsules C to be replenished is dropped from a high position, and thus the capsules C may be damaged. On the other hand, in the article dispensing apparatus 1 of the present embodiment, the three dividing members 11 can be detached from the rail 12, and the capsules C can be replenished with almost no fall of the capsules C by detaching the three dividing members according to the remaining amount of the capsules C, so that the damage of the capsules C can be prevented. The dividing member 11 is provided with the handle portion 11a, and the handle portion 11a can be gripped with fingers and lifted as it is, so that the dividing member can be easily removed from the rail 12. It should be noted that the dividing member 11 also can be easily lifted up by placing a finger on the opening 11b provided in the dividing member 11.

By the way, in this type of article dispensing apparatus, capsules may be clogged in the hopper. In order to eliminate the clogging in such a case, it is necessary to expose the hopper provided below the storage space and take out the clogged capsules, and for this purpose, it is necessary to take out almost all the capsules in the storage space. When the number of capsules to be stored increases, the work becomes more complicated and a heavy burden is imposed.

On the other hand, according to the article dispensing apparatus 1 of the present embodiment, it is possible to greatly reduce the number of capsules C to be taken out from the storage space S. That is, when it is necessary to expose the hopper 18, the two dividing members 11 are slid upward in a state where one dividing member 11 is taken out as illustrated in FIG. 4. Then, the opening 11b of the dividing member 11 overlaps the receiving portion 13d of the first partition member 13, and a bar-shaped member B such as a tip of a screwdriver is inserted into the opening 11b and the receiving portion 13d. As a result, since the dividing member 11 shifted upward can be supported by the bar-shaped member B, a lower portion of the dividing member 11 can be opened. Thereafter, an arm is inserted below the opened dividing member 11, and the first moving member 16 is moved from the front side to the rear side with respect to the first partition member 13. This makes it possible to fill a gap provided between the first rear side end portion 13b and the rear panel 4, so that the capsules C positioned above the first partition member 13 do not move below the first partition member 13. That is, in order to take out the capsules C clogged in the hopper 18, only the capsules C around the hopper 18 need to be taken out. The first partition member 13 extends obliquely downward from the first front side end portion 13a to the first rear side end portion 13b located on the rear side, and the front side below the first partition member 13 is largely opened as compared with the rear side. Therefore, the work of moving the first moving member 16, and the work of taking out the capsules C can be easily performed.

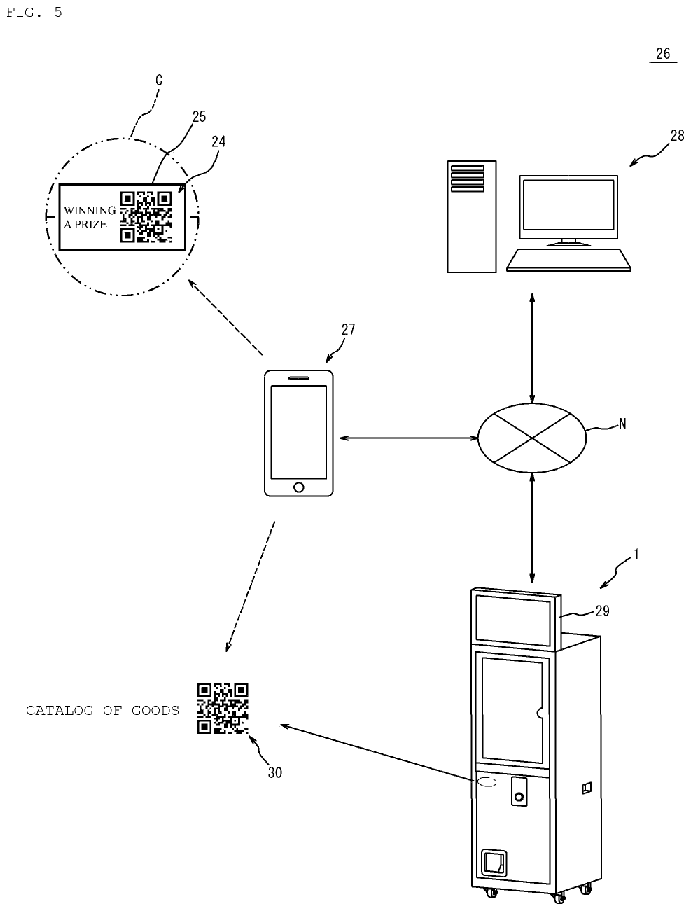

Premiums to be put in the capsules C may be of any kind such as toys, confectionery, clothes, and small electric appliances, but it is not possible to put such a large gift. In addition, if expensive premiums are put in the capsules C, there is a concern in terms of security. Therefore, small cards may be inserted into the capsules C, and goods may be provided in exchange for the cards at a counter of a store where the article dispensing apparatus 1 is installed. In addition, the cards 25 on which premium exchange access information 24 such as a two-dimensional code as illustrated in FIG. 5 are displayed may be stored in the capsules C, and premiums may be provided using the premium exchange access information 24. In providing the premiums using the premium exchange access information 24, for example, the following system and method can be adopted.

A system 26 used in providing the premiums in the present embodiment includes a user terminal device 27, an administrator terminal device 28, the article dispensing apparatus 1 described above, and a communication network N.

The user terminal device 27, the administrator terminal device 28, and the article dispensing apparatus 1 can mutually transmit and receive information via the communication network N. The user terminal device 27 and the administrator terminal device 28 may be, for example, portable terminal devices such as a smartphone and a tablet terminal, or may be desktop type or server type stationary terminal devices. In the present embodiment, the user terminal device 27 is a portable terminal device, and the administrator terminal device 28 is a stationary terminal device. Here, the user terminal device 27 includes an input unit such as a camera for reading the premium exchange access information 24 and a touch panel for inputting various types of information. The touch panel also has a function for displaying websites and the like. The user terminal device 27 is also provided with a storage means such as a semiconductor memory that stores a program and the like, and a control means such as a CPU that controls the operation of the user terminal device 27 by reading and executing the program. In addition, the administrator terminal device 28 is provided with an input means such as a keyboard and a mouse, an output means such as an LCD and an organic EL display, a storage means such as a semiconductor memory that stores various kinds of information related to a user in addition to a program related to the administrator terminal device 28 and data of a website, and a control means such as a CPU that controls the operation of the administrator terminal device 28 by reading and executing the program.

In addition, the article dispensing apparatus 1 of the present embodiment includes a display device 29 (for example, an LCD, an organic EL display, or the like) capable of displaying characters, images, and the like. Further, the article dispensing apparatus 1 displays premium introduction information 30 such as a two-dimensional code. Note that the article dispensing apparatus 1 of the present embodiment can mutually transmit and receive information to and from the administrator terminal device 28 via the communication network N, and is configured to store the received information.

The communication network N is, for example, a WAN, the Internet, or the like in addition to a LAN using a dedicated line, a mobile communication network, a communication satellite network, a telephone line, a CATV line, or the like.

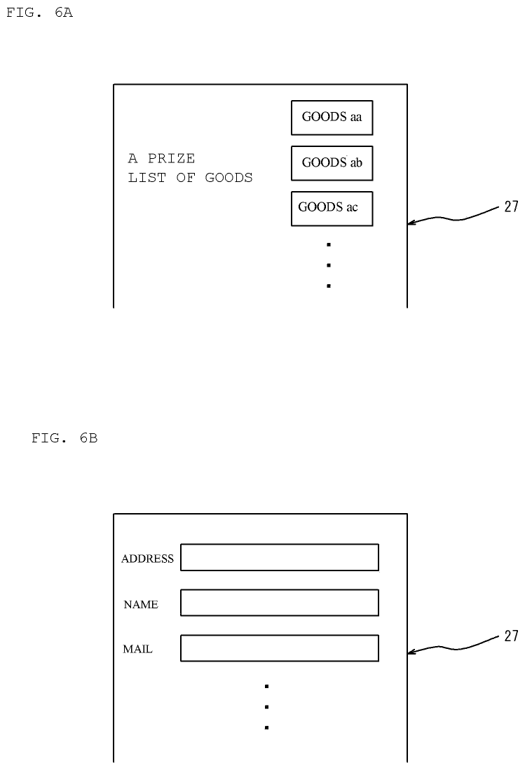

Hereinafter, a method of providing a premium by such a system 26 will be described. It is assumed that a card 25 related to winning of the A prize as illustrated in FIG. 5 is stored in the capsule C dispensed from the article dispensing apparatus 1 by a user. Then, when the user reads the premium exchange access information 24 using the camera of the user terminal device 27, the control means of the user terminal device 27 exchanges information with the administrator terminal device 28 via the communication network N, and displays a website corresponding to the premium exchange access information 24 on the touch panel of the user terminal device 27 based on a data stored in the storage means of the administrator terminal device 28 (see FIG. 6A). In the website of the present embodiment, goods information (a photograph, a feature, or the like of each goods) regarding various goods (goods aa, goods ab, goods ac . . . ) included in the A prize is displayed.

Then, when the user selects, for example, the goods ab as a desired premium on the touch panel, the user terminal device 27 transmits information thereof to the administrator terminal device 28 via the communication network N. On the other hand, the administrator terminal device 28 transmits, to the user terminal device 27, information regarding a website for inputting an address, a name, an e-mail address, and the like of the user who is a shipping address of the goods ab. As a result, a website as illustrated in FIG. 6B is displayed on the touch panel of the user terminal device 27.

Then, when the user inputs user information such as an address as a shipping address of the goods ab, a name of the user, and an e-mail address using the touch panel, the user terminal device 27 transmits the user information to the administrator terminal device 28 via the communication network N. As a result, the storage means of the administrator terminal device 28 stores the user information for shipping the goods ab.

Thereafter, an administrator operates the administrator terminal device 28 to refer to the user information and ship the goods ab. In this manner, the user can receive the desired goods ab.

Meanwhile, in the capsules C of the article dispensing apparatus 1, winning cards of other prizes such as the B prize and the C prize . . . are stored in addition to the card 25 related to the winning of the A prize. The system 26 according to the present embodiment also has a function of presenting goods information related to these prizes to a user.

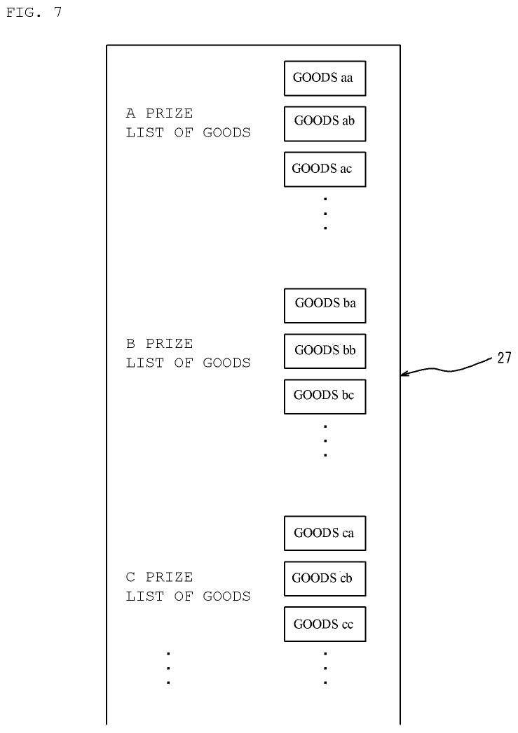

First, a method of presenting goods information related to the A prize, the B prize, the C prize, . . . to the user terminal device 27 will be described. When a user reads the premium introduction information 30 such as a two-dimensional code illustrated in FIG. 5 with the camera of the user terminal device 27, the control means of the user terminal device 27 exchanges information with the administrator terminal device 28 via the communication network N. Then, the administrator terminal device 28 transmits, to the user terminal device 27, information of a website in which goods aa . . . related to the A prize, goods ba . . . related to the B prize, goods ca . . . related to the C prize, and the like are posted, on the basis of a data stored in the storage means of the administrator terminal device 28. As a result, a website as illustrated in FIG. 7 is displayed on the touch panel of the user terminal device 27.

The goods information related to the A prize, the B prize, and the C prize . . . can also be displayed on the display device 29 of the article dispensing apparatus 1 illustrated in FIG. 5. For example, when an administrator operates the administrator terminal device 28 to transmit the goods information regarding the A prize, the B prize, the C prize . . . to the article dispensing apparatus 1 via the communication network N, this information is stored in the article dispensing apparatus 1. Then, the article dispensing apparatus 1 displays the goods information such as goods aa . . . related to the A prize, goods ba . . . related to the B prize, and goods ca . . . related to the C prize on the display device 29 at a predetermined timing.

As described above, according to the system 26 of the present embodiment, since the goods obtained from the capsule C stored in the article dispensing apparatus 1 can be displayed on the user terminal device 27 or the display device 29, the appeal effect to a user can be enhanced.

The system 26 of the present embodiment also has a function of giving a right to participate in a predetermined event (for example, a lottery) to a user who has won the A prize or the like. As described above, the user information such as an address, a name, and an e-mail address of a user who has won the A prize or the like is stored in the storage means of the administrator terminal device 28. Therefore, when an event is held, a permit or the like to participate in the event can be sent to a user who has won the A prize or the like. Note that, for example, if goods more expensive than the A prize or the like are provided to an event winner, a user of the article dispensing apparatus 1 can have expectations, and thus the appeal effect can be further enhanced. In addition, by storing the goods information regarding the goods obtained in the event in the storage means of the administrator terminal device 28, it is possible to display the goods information on the user terminal device 27 or the display device 29 as described above, and thus, it is possible to further enhance the appeal effect.

Although one embodiment of the present invention has been explained above, the present invention is not limited to the specific embodiment, and various modifications and changes can be made within the scope of the gist of the present invention described in the claims unless otherwise limited in the above-described explanation. In addition, the effects of the above embodiment are merely examples of the effects caused by the present invention, and do not mean that effects of the present invention are limited to the above effects.

For example, in the present embodiment, two partition members (the first partition member 13 and the second partition member 14) are provided, but one partition member or three or more partition members may be provided. The first partition member 13 and the second partition member 14 are inclined downward from the front side to the rear side (or inclined downward from the rear side to the front side) in the above-described embodiment, but may be inclined downward from the left side to the right side (or inclined downward from the right side to the left side). When a plurality of partition members is provided, as in the above-described embodiment, it is preferable that the direction of inclination of the partition members located immediately above one partition member is reversed with respect to the one partition member.

In addition, the receiving portion 13d is a circular hole provided in the first front bent portion 13c as illustrated in FIG. 2 in the above-described embodiment, but is not limited to this form as long as it can support the bar-shaped member B inserted into the opening 11b of the dividing member 11. That is, the bar-shaped member B inserted into the opening 11b can be supported by the first front side end portion 13a, and the first front side end portion 13a can function as the receiving portion 13d.

In the article dispensing apparatus 1 of the present embodiment, the premium introduction information 30 is displayed below the door 8 of the article dispensing apparatus 1, but the premium introduction information 30 may be displayed on the display device 29. Further, when the display device 29 is caused to function, the article dispensing apparatus 1 is not limited to one connected to the communication network N. For example, an external storage device may be connected to the article dispensing apparatus 1, and the goods information may be displayed on the display device 29 on the basis of the information stored in the external storage device.

### REFERENCE SIGNS LIST

1 article dispensing apparatus
2 right panel
3 left panel
4 rear panel
5 upper panel
6 lower panel
7 front lower panel
8 door
9 storage unit
10 dispensing unit
11 dividing member
11a handle portion
11b opening
12 rail
12a front plate-shaped portion
12b rear plate-shaped portion
12c notch portion
13 first partition member (partition member)
13a first front side end portion (one side end portion)
13b first rear side end portion (other side end portion)
13c first front bent portion
13d receiving portion
13e first left side bent portion
14 second partition member (partition member)
14a second front side end portion (other side end portion)
14b second rear side end portion (one side end portion)
14e second left side bent portion
15 bracket
16 first moving member
17 second moving member
18 hopper
18a hopper upper portion
18b hopper lower portion
18c chute hole
19 rotary board
19a through hole
20 button
21 chute portion
22 box
23 dispensing port
24 premium exchange access information
25 card
26 system
27 user terminal device
28 administrator terminal device
29 display device
30 premium introduction information
B bar-shaped member
C capsule (article)
N communication network
S storage space

1. An article dispensing apparatus comprising: a storage unit configured to store a plurality of articles; and a dispensing unit configured to be provided below the storage unit and dispense at least one article from the storage unit,
wherein the storage unit includes a partition member extending obliquely downward from a one side end portion positioned on one side to an other side end portion positioned on the other side above the dispensing unit to support the articles, and configured to drop the articles from the other side end portion to the dispensing unit.

2. The article dispensing apparatus according to claim 1, further comprising a moving member configured to be movably attached to the partition member in a direction from the one side toward the other side, allow the articles to fall from the other side end portion to the dispensing unit when moved to the one side, and prevent the articles from falling from the other side end portion to the dispensing unit when moved to the other side.

3. The article dispensing apparatus according to claim 1, wherein the storage unit includes a rail provided inside an openable and closable door, and a dividing member slidably supported by the rail, and
the rail has a notch portion to which the dividing member is attachable at an upper portion of the rail.

4. The article dispensing apparatus according to claim 3, wherein the dividing member has an opening into which a bar-shaped member is insertable, and
the partition member includes a receiving portion that supports the bar-shaped member in a state where the dividing member is slid upward and the bar-shaped member is inserted into the opening.

5. The article dispensing apparatus according to claim 2, wherein the storage unit includes a rail provided inside an openable and closable door, and a dividing member slidably supported by the rail, and
the rail has a notch portion to which the dividing member is attachable at an upper portion of the rail.

6. The article dispensing apparatus according to claim 5, wherein the dividing member has an opening into which a bar-shaped member is insertable, and
the partition member includes a receiving portion that supports the bar-shaped member in a state where the dividing member is slid upward and the bar-shaped member is inserted into the opening.
